(19) United States
(12) Patent Application Publication
(10) Pub. No.: US 2015/0006276 A1
(43) Pub. Date: Jan. 1, 2015

(54) MODIFYING ADVERTISEMENTS BASED ON INDIRECT INTERACTIONS

(71) Applicant: LinkedIn Corporation, Mountain View, CA (US)

(72) Inventor: Tomer Cohen, Mountain View, CA (US)

(21) Appl. No.: 13/931,717

(22) Filed: Jun. 28, 2013

(51) Int. Cl. G06Q 30/02

(52) U.S. Cl. CPC G06Q 30/0244
USPC 705/14.43

(57) ABSTRACT

A method of enhancing advertisements to be presented to user on a device is disclosed. A specification of an advertisement that is to be presented to the user on the device is received. The specification of the advertisement is associated with an instruction pertaining to the advertisement that is to be executed based on a direct interaction with the advertisement by the user. An enhancement to the specification of the advertisement is added. The enhancement associates the specification of the advertisement with an additional instruction pertaining to the advertisement. The additional instruction is to be executed based on an indirect interaction with the advertisement by the user. The enhanced specification of the online advertisement is provided to an advertisement engine. The advertisement engine is configured to present the online advertisement to the user and execute at least one of the instruction and the additional instruction.

### TECHNICAL FIELD

This application relates generally to the technical field of internet advertising, and, in one specific example, to modifying an advertisement that is being presented to a user on a device based on a detection of an indirect interaction with the advertisement by the user.

### BACKGROUND

Internet advertising may be presented to a user of a device while the user is using the device. For example, an advertisement may be presented within a web page that the user is browsing in a web browser application. Or an advertisement may be presented to the user while the user is playing a game, perhaps within a context of the game.

Typically, if the user sees an advertisement that the user is interested in, the user will interact directly with the advertisement (e.g., click on the advertisement). In response, the user's current activity on the device may be interrupted as the user is provided with more information about the subject of the advertisement.

For example, based on a direct interaction by the user with the advertisement, a web browser application may be launched on the device of the user and a web page may be loaded into the web browser application to provide the user with more information about the subject of the advertisement. Or, based on a direct interaction by the user with the advertisement, another application pertaining to the subject of the advertisement may be launched on the device of the user, taking the focus away from an application that the user is currently using.

Because the user knows that the user's current activity will be interrupted if the user directly interacts with the advertisement, the user may choose to ignore the advertisement even though the user may have some interest in a subject of the advertisement.

### BRIEF DESCRIPTION OF THE DRAWINGS

Some embodiments are illustrated by way of example and not limitation in the figures of the accompanying drawings in which:

FIG. 1 is a network diagram depicting a client-server system within which various example embodiments may be deployed;

FIG. 2 is a block diagram illustrating example modules that may implement various example embodiments;

FIG. 3 is a flow chart illustrating example operations of a method of presenting an enhanced online advertisement to a user;

FIG. 4 is a flow chart illustrating example operations of a method of modifying an advertisement being presented to a user based on an indirect interaction by the user with the advertisement;

FIG. 5 is a flow chart illustrating example operations of a method of presenting various states of an advertisement based on indirect interactions by a user with the advertisement;

FIG. 6 is a flow chart illustrating example operations of a method of modifying an advertisement based on an indirect interaction by the user with the advertisement without leaving a current context;

FIG. 7 is an interaction diagram depicting an example indirect interaction by a user with an advertisement; and

FIG. 8 is a block diagram of a machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the inventive subject matter. It will be evident, however, to those skilled in the art that embodiments may be practiced without these specific details. Further, to avoid obscuring the inventive concepts in unnecessary detail, well-known instruction instances, protocols, structures, and techniques have not been shown in detail. As used herein, the term “or” may be construed in an inclusive or exclusive sense, the term “user” may be construed to include a person or a machine, and the term “interface” may be construed to include an application program interface (API) or a user interface.

In various embodiments, a method of enhancing advertisements to be presented to user on a device is disclosed. A specification of an advertisement that is to be presented to the user on the device is received. The specification of the advertisement is associated with an instruction pertaining to the advertisement that is to be executed based on a direct interaction with the advertisement by the user. An enhancement to the specification of the advertisement is added. The enhancement associates the specification of the advertisement with an additional instruction pertaining to the advertisement. The additional instruction is to be executed based on an indirect interaction with the advertisement by the user. The enhanced specification of the online advertisement is provided to an advertisement engine. The advertisement engine is configured to present the online advertisement to the user and execute at least one of the instruction and the additional instruction.

This method and other methods or embodiments disclosed herein may be implemented as a computer system having one or more modules (e.g., hardware modules or software modules). Such modules may be executed by one or more processors of the computer system. This method and other methods or embodiments disclosed herein may be embodied as instructions stored on a machine-readable medium that, when executed by one or more processors, cause the one or more processors to perform the instructions.

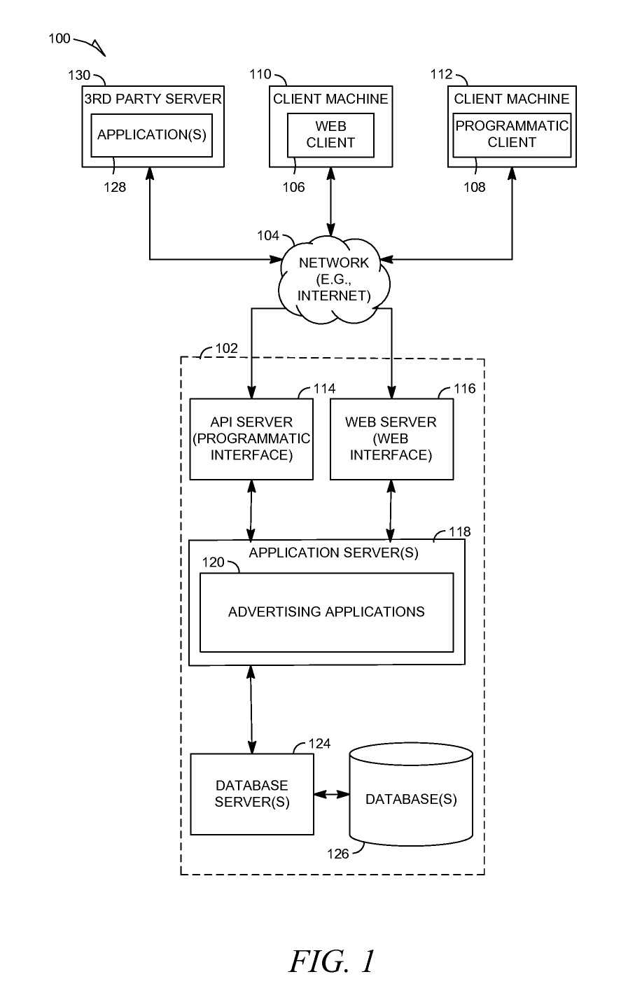

FIG. 1 is a network diagram depicting a client-server system 100, within which various example embodiments may be deployed. A networked system 102, in the example forms of a social-networking system or other communication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash.) and a programmatic client 108 executing on respective client machines 110 and 112. Each of the one or more clients 106, 108 may include a software application module (e.g., a plug-in, add-in, or macro) that adds a specific service or feature to a larger system.

Within the networked system 102, an API server 114 and a web server 116 are coupled to, and provide programmatic and web interfaces respectively to, one or more application servers 118. The application servers 118 host one or more social-networking application(s) 120. The application servers 118 are, in turn, shown to be coupled to one or more databases servers 124 that facilitate access to one or more databases or NoSQL or non-relational data stores 126.

The applications 120 may provide a number of functions and services to users who access the networked system 102. While the applications are shown in FIG. 1 to form part of the networked system 102, in alternative embodiments, the applications may form part of a service that is separate and distinct from the networked system 102.

Further, while the system 100 shown in FIG. 1 employs a client-server architecture, various embodiments are, of course, not limited to such an architecture, and could equally well find application in a distributed, or peer-to-peer, architecture system, for example. The various applications could also be implemented as standalone software programs, which do not necessarily have computer networking capabilities. Additionally, although FIG. 1 depicts machines 130, 110, and 112 as being coupled to a networked system 102, it will be readily apparent to one skilled in the art that machines 130, 110, and 112, as well as client 128, 106, and 108, may be coupled to multiple additional networked systems. For example, the clients 128, 106, and 108 may be coupled to multiple applications, such as applications 120.

The web client 106 accesses the various applications 120 via the web interface supported by the web server 116 or the web server 166 respectively. Similarly, the programmatic client 108 accesses the various services and functions provided by the applications 120 via the programmatic interface provided by the API server 114 and API server 164, respectively. The programmatic client 108 may, for example, perform batch-mode communications between the programmatic client 108 and the networked systems 102.

Examples of client machines embodied as mobile devices may include a laptop computer, a tablet computer (e.g., an iPad), a mobile or smart phone (e.g., an iPhone), a smart watch (e.g., a Pebble E-Paper Watch), an augmented reality head-mounted display (e.g., Google Glass), and so on.

FIG. 1 also illustrates application(s) 128, executing on a third party server machine 130, as having programmatic access to the networked systems 102 via the programmatic interface provided by the API server 114 and the API server 164, respectively. For example, the application(s) 128 may, utilizing information retrieved from the networked systems 102, support one or more features or functions on a website hosted by the third party. The third party website may, for example, provide one or more social-networking functions that are supported by the relevant applications of the networked system 102.

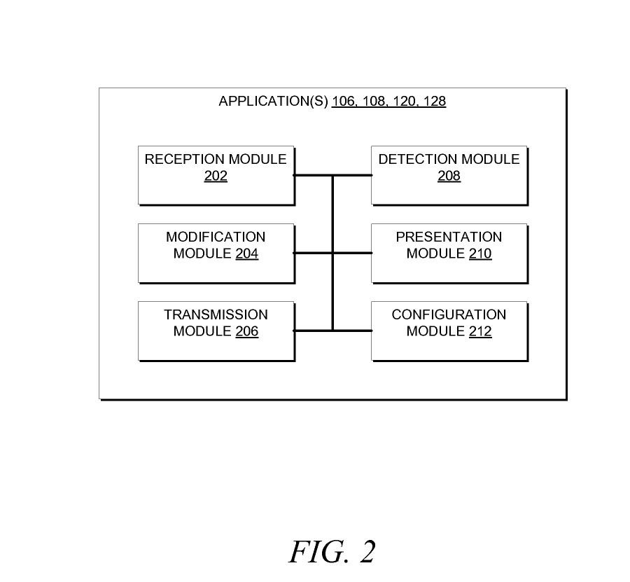

FIG. 2 is a block diagram illustrating example modules of the application(s) 106, 108, 120, and 128 of FIG. 1. A reception module 202 may be configured to receive specifications of advertisements from advertisers. A specification of an advertisement may include information pertaining to a subject matter of the advertisements, such as text or images. A specification of an advertisement may also associate an advertisement with to an instruction to perform an action based on a direct interaction by the user with the advertisement. For example, the instruction may specify that a clicking of the advertisement by the user is to result in a web browser being launched on the device of the user to access a web page on the Internet pertaining to the subject matter of the advertisement.

A modification module 204 may be configured to modify a specification of an advertisement. For example, the modification module 204 may be configured to add an enhancement to a specification of an advertisement. An enhancement may, for example, associate the specification of the advertisement with an additional instruction pertaining to the advertisement. The additional instruction may, for example, enable the user to interact indirectly with the advertisement. Thus, the user may be able to learn more about a subject matter of the advertisement without suffering an interruption that may occur if the user were to directly interact with the advertisement.

A transmission module 206 may be configured to transmit an enhanced specification of an advertisement to an advertising engine. For example, the transmission module 206 may transmit the enhanced specification to an advertising engine executing on a device of the user. The advertising engine may be configured to execute at least one of the instruction and the additional instruction. In various embodiments, the advertising engine may be configured to implement the instruction based on a direct interaction by the user with the advertisement and the additional instruction based on an indirect interaction by the user with the advertisement.

A detection module 208 may be configured to detect a direct interaction by the user with the advertisement and an indirect interaction by the user with the advertisement. Whether an action by the user is interpreted as a direct interaction or an indirect interaction may be determined by predetermined mappings or by mappings received from the advertiser, as is described in more detail below.

A presentation module 210 may be configured to present an advertisement to the user on a device. For example, the presentation module 210 may present an advertisement to the user within a context in which the user is using the device (e.g., within an application, such as a game, in a space reserved within the application for such advertising).

A configuration module 212 may be configured to establish mappings between actions performed by the user and modifications that may be made to an advertisement. For example, the configuration module 212 may, based on a specification received from an advertiser, determine that an action by the user to rotate the device is an indirect interaction by the user with an advertisement that is to cause a three-dimensional object depicted within the advertisement to rotate.

In various embodiments one or more of the modules 202-212 or portions of the modules 202-212 may be included in server applications 120 or in a client, such as the application(s) 128, web client 106, or programmatic client 108 of FIG. 1. In other words, the modules may be distributed among the servers and clients such that some or all of the functionality is provided on the server side or some or all of the functionality is provided on the client side.

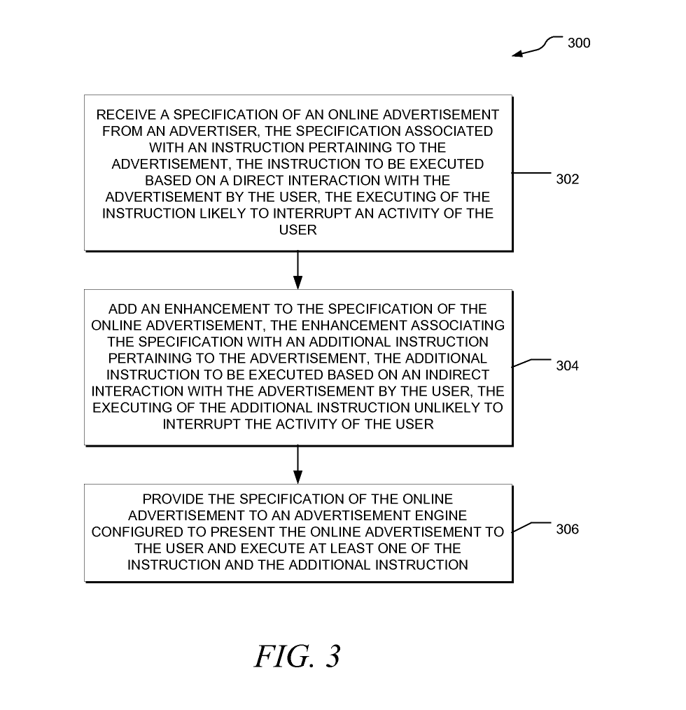

FIG. 3 is a flow chart illustrating example operations of a method 300 of presenting an enhanced online advertisement to a user. In various embodiments, the method 300 may be implemented by the modules 202-212 of FIG. 2. At operation 302, the reception module 202 may receive a specification of an online advertisement from an advertiser. In various embodiments, the specification may include one or more images associated with the advertisement. The specification may also include an association of an instruction with the advertisement. The instruction may specify, for example, that information about a subject of the advertisement is to be displayed in a web browser on a device of the user based on a direct interaction by the user with the advertisement (e.g., a clicking on the advertisement by the user). Or the instruction may specify that an application is to be launched on a device of the user based on a direct interaction by the user with the advertisement.

In various embodiments, an implementation of the instruction associated with the advertisement may be likely to interrupt an activity of the user. For example, if the user interacts directly with the advertisement while playing a game on the device, a web browser application may be launched on the device, a page loaded into the web browser based on an accessing of a uniform resource locator on the Internet, and content displayed on the web browser pertaining to the advertisement. Thus, the implementation the instruction associated with the advertisement may interrupt the user from playing the game.

At operation 304, the modification module 204 may modify the specification of the advertisement. For example, the modification module 204 may add an enhancement to the specification of the online advertisement. In various embodiments, the enhancement may associate the online advertisement with an additional instruction pertaining to the advertisement. In various embodiments, the additional instruction may specify, for example, that an aspect of the advertisement is to change based on an indirect interaction with the advertisement by the user. For example, the additional instruction may specify that a property of the advertisement (e.g., its size, color, shape, or content) is to change. For example, the additional instruction may specify that the color of an image contained in the advertisement is to change based on the user interacting with a gyroscope on the device (e.g., causing a user interface on the device to switch from landscape mode to portrait mode). Thus, without directly interacting with the advertisement (e.g., without clicking on the advertisement), the user may nevertheless indirectly interact with the advertisement (e.g., by performing an action that triggers an execution of the additional instruction associated with the advertisement).

In various embodiments, the additional instruction may be selected based on a likelihood that the additional instruction will not interrupt a current activity of the user with respect to the device. For example, the additional instruction may be selected based on a determination that an execution of the additional instruction would not change a context in which the user is operating the device (e.g., that an execution of the additional instruction would not launch or set focus on a different application than one of the applications that the user is currently using). Or the additional instruction may be selected based on a determination that an execution of the additional instruction would not prevent the user from having sufficient network, processing power, or other resources to proceed with a current activity that the user is performing on the device.

At operation 306, the transmission module 206 transmits the enhanced specification of the online advertisement to an advertisement engine that is configured to present the online advertisement to the user (e.g., within an advertisement space of an application that the user is executing on the device). In various embodiments, the advertisement engine is configured to present the online advertisement to the user and execute at least one of the instruction and the additional instruction. For example, based on a detection of a direct interaction by the user with the advertisement, the advertisement engine may execute an instruction to launch a web browser application on the device to access content pertaining to a subject of the advertisement. Or, based on a detection of an indirect interaction by the user with the advertisement, the advertisement engine may execute an instruction to change an aspect of the advertisement without interrupting the user from an activity that the user is currently performing on the device.

Thus, in various embodiments, a user who is interested in a subject matter of an advertisement, but who does not want to be interrupted from a task that the user is currently performing on a device on which the advertisement is being presented on the device, may interact indirectly with the advertisement to learn more about a subject matter of the advertisement. Based on the modifications of aspects of the advertisement that occur during the indirect interactions by the user with the advertisement, the user may be induced to directly interact with the advertisement (e.g., click on the advertisement), and consequently be taken out of a current context in which the user is using the device. Alternatively, the user may learn answers to questions that the user may have about the subject matter of the advertisement through the indirect interactions with the advertisement and thus choose not to directly interact with the advertisement. In various embodiments, the advertisement engine may count one or more indirect interactions with the advertisement as advertisement impressions even if the user does not directly interact with the advertisement.

Additionally, an advertiser who submits an advertisement may need only to provide a non-enhanced form of the advertisement and may not need any knowledge of various enhancements that may be applied to the advertisement prior to a presentation of the advertisement to the user. The non-enhanced form of the advertisement may be, for example, a generic form in which the advertiser would submit the advertisement to a separate entity, such as a search engine (e.g., Google or Yahoo) or other Internet site the supports advertising. In various embodiments, the modification module 204 enhances the advertisement automatically to enable indirect interactions by the user with the advertisement to change an aspect of the advertisement being displayed to the user on the device.

In various embodiments, the modification module 204 may have knowledge of the various enhancements that may be applied and further may have an option to specify how the various enhancements are applied or implemented by the advertisement engine. For example, the reception module 202 may receive a specification from the advertiser that specifies indirect interactions with the advertisement by the user that trigger changes to the advertisement. For example, the advertiser may specify a mapping between various indirect interactions supported by the device on which the advertisement is being presented and various modifications that may be made to aspects of the advertisement as the advertisement is being presented. For example, the advertiser may access a user interface (e.g., via the configuration module 212) that presents possible ways that the user of a device may interact indirectly with the advertisement and possible modifications that may be made to the advertisement or an aspect of the advertisement. The advertiser may then use the user interface to specify a mapping of the interactions to the modifications.

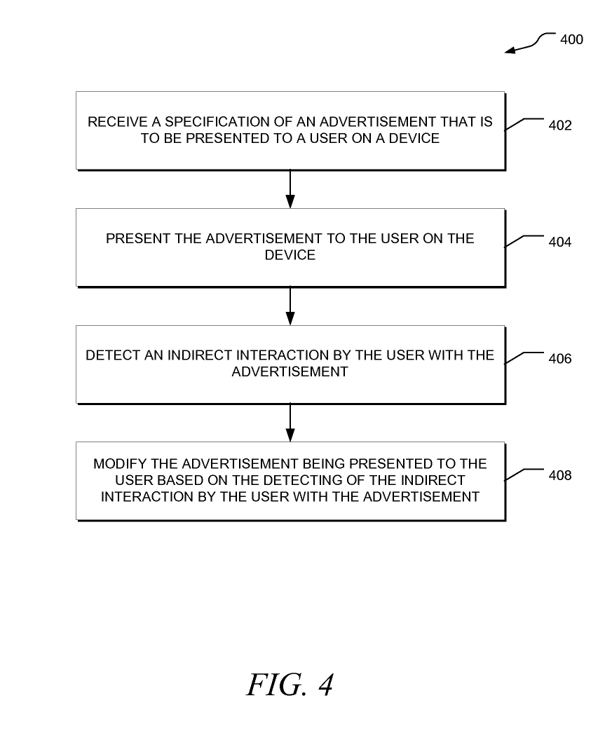

FIG. 4 is a flow chart illustrating example operations of a method 400 of modifying an advertisement being presented to a user based on an indirect interaction by the user with the advertisement. In various embodiments, the method 300 may be implemented by the modules 202-212 of FIG. 2. At operation 402, the reception module 202 receives a specification of an advertisement that is to be presented to a user on a device. At operation 404, the presentation module 210 presents the advertisement to the user on the device.

At operation 406, the detection module 208 detects an indirect activation of the advertisement by the user. For example, the detection module 208 detects that the user has performed an action with respect to the device that has been defined as an indirection action. Such actions may include an interaction by the user that engages a component of the device, such as a sensor (e.g., a GPS, gyroscope, compass, microphone, accelerometer, magnetometer, or other sensor), camera, touchscreen, network adapter, and so on. Any engagement by the user with the device may be associated (e.g., via the configuration module 212) with an indirect interaction by the user with the advertisement. Thus, a user may be able to indirectly interact with an advertisement by moving (e.g., engaging the GPS sensor of the device), turning around (e.g., engaging the compass of the device), swiping a finger across the device in a certain way (e.g., engaging the touchscreen of the device to scroll, minimize, or maximize content displayed on the device), connecting to a wireless network (e.g., engaging the network adapter of the device), making a Bluetooth connection (e.g., engaging a Bluetooth receive on the device), preparing to capture a picture or video on the device (e.g., launching an application on the device that engages the camera of the device), changing an orientation of the device (e.g., activating the gyroscope or accelerometer of the device by moving the device), turning on the device, activating any switch or button on the device, flipping a cover containing the device open or closed, rotating the device, flipping the device, and so on.

An action by the user may be interpreted as an indirect interaction by the user with the advertisement based on the action not being one of a set of predefined actions that are defined to be direct interactions by the user with the advertisement (e.g., clicking on the advertisement).

At operation 408, the modification module 204 modifies the advertisement being presented to the user based on the detecting of the indirect interaction by the user with the advertisement. For example, the modification module 204 changes an aspect of the advertisement (e.g., color, size, or content of the advertisement) based on a detecting of the indirection interaction by the user with the advertisement.

In various embodiments, the indirect interaction by the user with the advertisement may include performing an action within a game contained in the advertisement. For example, the advertisement being presented to the user may include instructions to the user for interacting indirectly with the advertisement to perform an action within the game. For example, the advertisement may instruct the user to physically orient the device to the left or right to aim a weapon at a target depicted in the advertisement or to tap the touchscreen of the device to shoot the weapon. Thus, the user may be able to engage with the advertisement without clicking on the advertisement.

As another example, the advertisement may include an image of a subject of the advertisement, such as a car. By performing various actions, the user may be able to view the image in more detail. For example, by performing a particular action, the user may be able to open the subject, view the subject from a different angle, or simulate an activation of a feature of the subject. For example, if the subject of the advertisement is a car, the user may be able to view the car from different angles, open the car (e.g., hood, trunk, or doors), turn on the lights of the car, start the engine of the car, and so on, by interacting indirectly with the advertisement.

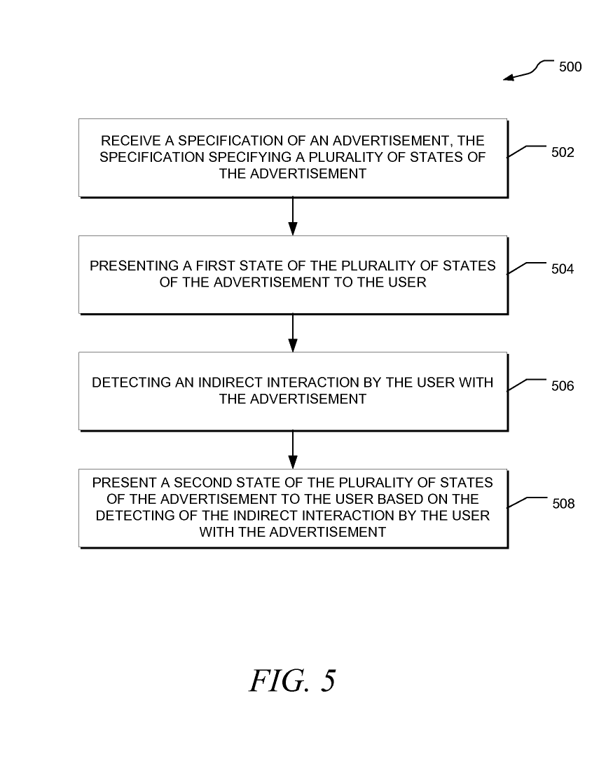

FIG. 5 is a flow chart illustrating example operations of a method 500 of presenting various states of an advertisement based on indirect interactions by a user with the advertisement. In various embodiments, the method 300 may be implemented by the modules 202-212 of FIG. 2. At operation 502, the reception module 202 receives a specification of the advertisement. In various embodiments, the specification specifies a plurality of states of the advertisement. The various states of the advertisement may include different images, sizes, colors, or other aspects of the advertisement itself or of content (e.g., images or text) included in the advertisement. For example, a first state of an advertisement may correspond to the first page of a story pertaining to a subject of the advertisement; a second state of the advertisement may correspond to the second page of the story; and so on. As another example, a first state of an advertisement may depict a person who is fully dressed; a second state of the advertisement may depict a person who is wearing one less item of clothing; and so on. As another example, a first state of an advertisement may pose a question to the user and a second state of the advertisement may provide the answer to the question. As another example, a first state of the advertisement may notify the user to perform a particular action (e.g., rotate the device) to receive a coupon code for a purchase of an item that is the subject of the advertisement and the second state of the advertisement may notify the user of the coupon code. As another example, the first state of the advertisement may depict content on one face of a three-dimensional object (e.g., a cube) depicted in the advertisement, the second state of the advertisement may depict content on a second face of the three-dimensional object, and so on.

In various embodiments, if a number of indirect interactions by the user with the advertisement transgress a threshold value (e.g., 5), the last of the number of indirect interactions may be interpreted as a direct interaction by the user with the advertisement (e.g., a clicking of the advertisement). Thus, for example, if a user reaches a last state of a plurality of states of the advertisement via direct interactions with the advertisement, the last indirect interaction by the user with the advertisement may be interpreted as a direct interaction by the user with the advertisement, which might cause, for example, a web browser to launch on the device of the user and a web page containing information pertaining to the subject of the advertisement to be displayed on the web browser

At operation 504, the presentation module 210 presents a first state of the plurality of states of the advertisement to the user. At operation 506, the detection module 208 detects an indirect interaction by the user with the advertisement. At operation 508, the presentation module 210 presents a second state of the plurality of states to the user based on the detecting of the indirect interaction by the user with the advertisement.

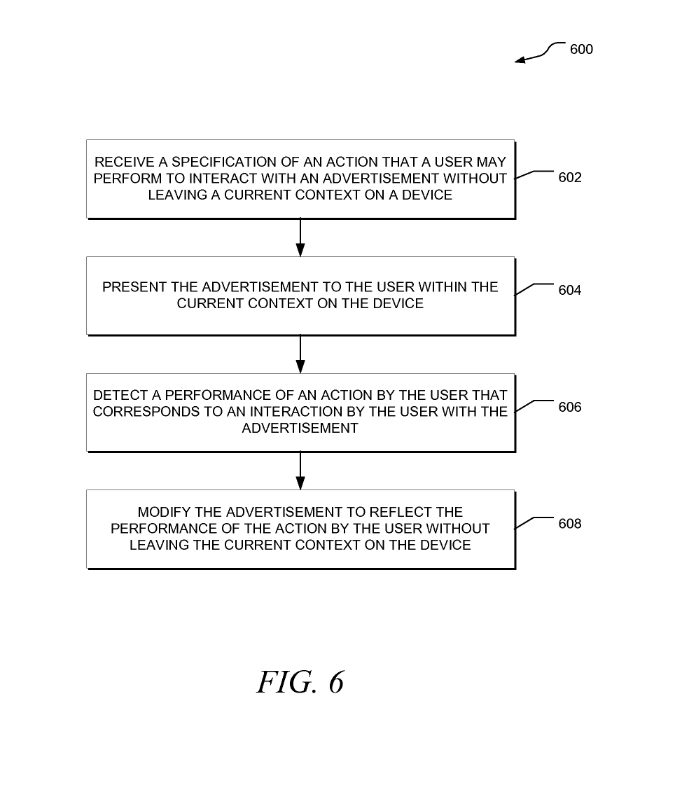

FIG. 6 is a flow chart illustrating example operations of a method 600 of modifying an advertisement based on an indirect interaction by the user with the advertisement without leaving the current context on the device.

At operation 602, the reception module 202 receives a specification of an action that a user may perform to interact with an advertisement without leaving a current context on the device.

At operation 604, the presentation module 210 presents the advertisement to the user within the current context on the device. For example, if a user is playing a game, the presentation module 210 may present the advertisement within the game (e.g., in a portion of the user interface of the game that is reserved for advertising). Or, if the user is browsing a web page, the presentation module 210 may present the advertisement within the web-browsing context (e.g., in a region of the user interface of the web browser that is reserved for advertising or in a region of the web page itself that is reserved for advertising). Thus, the advertising may be presented to the user in such a way that it does not disrupt a current activity of the user on the device.

At operation 606, the detection module 208 detects a performance of an action by the user that corresponds to an interaction by the user with the advertisement.

At operation 608, the modification module 204 modifies the advertisement to reflect the performance of the action by the user without leaving the current context on the device. For example, the modification module 204 modifies an aspect of the advertisement without launching a separate application on the device, changing the current focus from the application currently having focus on the device, or otherwise interrupting the user from a task that the user is currently performing on the device.

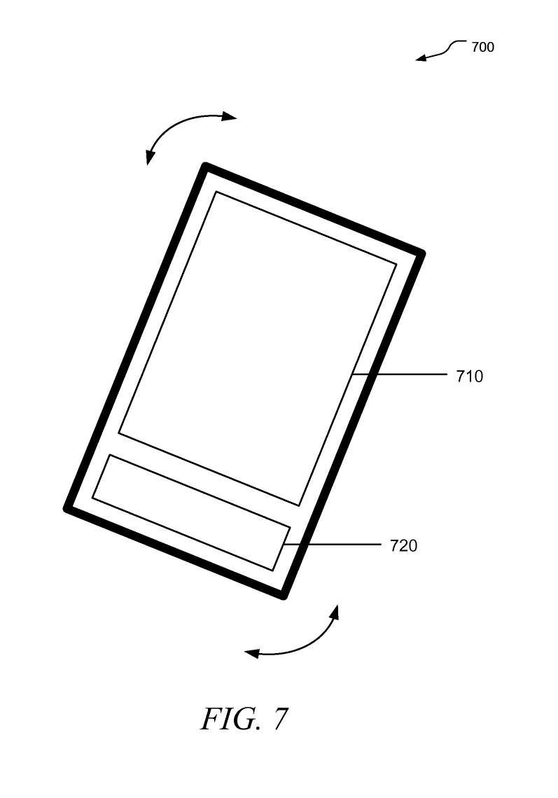

FIG. 7 is an interaction diagram depicting an example indirect interaction 700 by a user with an advertisement being presented on a device of the user. Here, while the user is using the device to view content 710 (e.g., while the user is browsing a web site using a web browser application executing the device), the user is also rotating the device left or right to indirectly interact with advertisement 720. Based on this indirect interaction by the user, the advertisement 720 may be updated to provide additional information to the user about a subject of the advertisement. However, the user may remain in the user's current context (e.g., a web browsing context). Thus, the user may continue on with his main task (e.g., viewing the content 710) while simultaneously learning more about a subject of the advertisement 720. Because the user knows that his indirect interaction with the advertisement may not significantly disrupt the user from the user's current task (e.g., by launching an application or brining up a new web page in the web browser), the user may be more likely to engage with the advertisement to learn more about the subject matter of the advertisement than if the only option for the user to learn more about the advertisement was to interact directly with the advertisement (e.g., click on the advertisement).

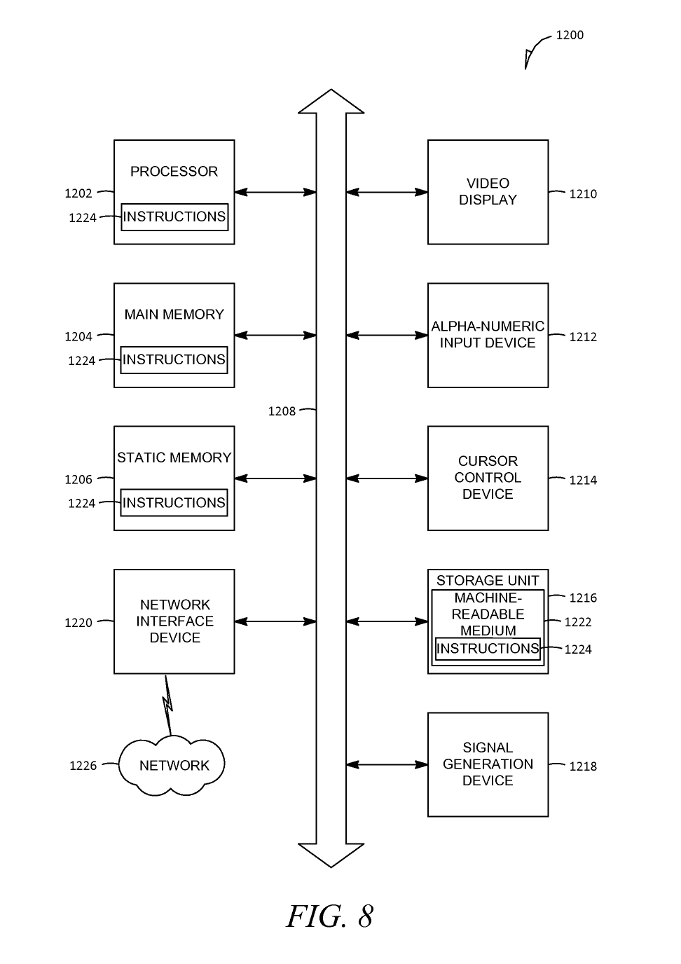

FIG. 8 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a storage unit 1216, a signal generation device 1218 (e.g., a speaker) and a network interface device 1220.

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

The instructions 1224 may further be transmitted or received over a communications network 1226 using a transmission medium. The network 1226 may be one of the networks 1220. The instructions 1224 may be transmitted using the network interface device 1220 and any one of a number of well-known transfer protocols (e.g., Hyper Text Transfer Protocol (HTTP)). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method comprising:
receiving from an advertiser a specification of an advertisement that is to be presented to a user on a device, the specification of the advertisement associated with an instruction pertaining to the advertisement, the instruction to be executed based on a direct interaction with the advertisement by the user;
selecting an additional instruction pertaining to the advertisement, the selecting of the additional instruction based on a likelihood that an executing of the additional instruction will interrupt an activity of the user of the device, the additional instruction to be executed based on an indirect interaction with the advertisement by the user;
adding an enhancement to the specification of the advertisement, the enhancement associating the specification with the additional instruction pertaining to the advertisement, the adding of the enhancement being performed by a processor; and
providing the enhanced specification of the advertisement to an advertisement engine configured to present the advertisement to the user, execute the instruction based on the direct interaction by the user, and execute the additional instruction based on the indirect interaction by the user.

2. (canceled)

3. The method of claim 1, wherein the indirect activation of the advertisement by the user is based on an activation of a hardware feature of the device, the hardware feature being one of a button, a switch, and a sensor.

4. The method of claim 1, further comprising receiving from the advertiser a mapping of the executing of the additional instruction to the indirect activation of the advertisement by the user.

5. The method of claim 4, wherein the executing of the additional instruction modifies a property of the advertisement.

6. (canceled)

7. (canceled)

8. A system comprising:
one or more modules implemented by one or more processors, the one or more modules configured to:
receive from an advertiser a specification of an advertisement that is to be presented to a user on a device, the specification of the advertisement associated with an instruction pertaining to the advertisement, the instruction to be executed based on a direct interaction by the user with the advertisement;
select an additional instruction pertaining to the advertisement, the selecting of the additional instruction based on a likelihood that an executing of the additional instruction will interrupt an activity of the user of the device, the additional instruction to be executed based on an indirect interaction with the advertisement by the user;
add an enhancement to the specification of the advertisement, the enhancement associating the specification with the additional instruction pertaining to the advertisement; and
provide the enhanced specification of the advertisement to an advertisement engine configured to present the advertisement to the user, execute the instruction and the additional instruction based on the direct interaction by the user, and execute the additional instruction based on the indirect interaction by the user.

9. (canceled)

10. The system of claim 8, wherein the indirect activation of the advertisement by the user is based on an activation of a hardware feature of the device, the hardware feature being one of a button, a switch, and a sensor.

11. The system of claim 8, the one or more processors further configured to receive from the advertiser a mapping of the executing of the additional instruction to the indirect activation of the advertisement by the user.

12. The system of claim 11, wherein the executing of the additional instruction modifies a property of the advertisement.

13. (canceled)

14. (canceled)

15. A non-transitory machine readable medium embodying a set of instructions that, when executed by a processor, cause the processor to perform operations, the operations comprising:
receiving from an advertiser a specification of an advertisement that is to be presented to a user on a device, the specification of the advertisement associated with an instruction pertaining to the advertisement, the instruction to be executed based on a direct interaction by the user with the advertisement;
selecting an additional instruction pertaining to the advertisement, the selecting of the additional instruction based on a likelihood that an executing of the additional instruction will interrupt an activity of the user of the device, the additional instruction to be executed based on an indirect interaction with the advertisement by the user;
adding an enhancement to the specification of the advertisement, the enhancement associating the specification with the additional instruction pertaining to the advertisement; and
providing the enhanced specification of the advertisement to an advertisement engine configured to present the advertisement to the, execute the instruction based on the direct interaction by the user, and execute the additional instruction based on the indirect interaction by the user.

16. (canceled)

17. The non-transitory machine readable medium of claim 15, wherein the indirect activation of the advertisement by the user is based on an activation of a hardware feature of the device, the hardware feature being one of a button, a switch, and a sensor.

18. The non-transitory machine readable of claim 15, the operations further comprising receiving from the advertiser a mapping of the executing of the additional instruction to the indirect activation of the advertisement by the user.

19. The non-transitory machine readable of claim 18, wherein the executing of the additional instruction modifies a property of the advertisement.

20. (canceled)

21. The method of claim 1, further comprising determining the likelihood that the additional instruction will interrupt the activity of the user of the device based on a determination that an execution of the additional instruction will not change a context in which the user is operating the device.

22. The method of claim 21, wherein the context includes a focus of an application to which the device is set.

23. The method of claim 21, wherein the determining of the likelihood that the additional instruction will interrupt the activity of the user of the device includes determining an impact of an execution of the additional instruction on resources of the device that are being used to support the activity of the user on the device.

24. (canceled)

25. The method of claim 1, wherein the adding of the enhancement is performed without knowledge of the advertiser.

26. The method of claim 1, wherein the executing of the additional instruction causes more information about a subject matter of the advertisement to be presented within the advertisement.

27. The method of claim 1, wherein the executing of the additional instruction allows the user to manipulate a graphical representation of a subject of the advertisement without moving a focus of the device away from an application that the user is currently using.

28. The method of claim 27, wherein the manipulating of the graphical representation of the subject includes simulating an activation of a feature of the subject.

29. The method of claim 27, wherein the subject is an automobile and the manipulating of the graphical representation of the automobile includes viewing a feature of the automobile in more detail.
